(19) United States
(12) Patent Application Publication
(10) Pub. No.: US 2009/0028085 A1
(43) Pub. Date: Jan. 29, 2009

(54) Method for providing measurement gaps

(75) Inventor: Steven Franklin, Guildford (GB)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 12/213,117

(22) Filed: Jun. 13, 2008

(30) Foreign Application Priority Data
Jun. 29, 2007 (GB) 0712702.0

(51) Int. Cl. H04H 20/71; H04J 3/06; H04J 1/00; H04J 3/00; H04B 7/212

(52) U.S. Cl. 370/312; 370/350; 370/343; 370/347; 370/345

(57) ABSTRACT

A method comprising interrupting the reception of a first transmission to receive a predetermined channel; determining from receipt of said predetermined channel first timing information associated with a second channel; and interrupting the reception of said first transmission at a time defined by said first timing information to receive said second channel.

The invention is related to a method for providing measurement gaps in a continuous transmission and in particular but not exclusively to a method for providing measurement gaps in a MBMS (Multimedia Broadcast/Multicast Service). The invention is also related to a system and apparatus for providing measurement gaps in a continuous transmission.

### BACKGROUND

A communication device is a device provided with an appropriate signal receiving and transmitting arrangement for enabling communication with other parties. Typically, a communication device is used for communication via a communication system for enabling the users thereof to receive and transmit communications such as speech and data. A communications system can be seen as a facility that enables communication sessions between two or more entities such as the communication devices and/or other nodes associated with the communication system.

Subscribers to or users of a communications system may be offered and provided with numerous services via their communication devices. Examples of these services include two-way or multi-way calls, data communication or multimedia services or simply an access to a data communications network system such as the Internet.

Users may also be provided with broadcast or multicast content such as television or radio programmes. An example of such content may be provided by a multimedia broadcast/multicast service (MBMS) server which broadcasts or multicasts information to multiple participants over a geographical area. The server can provide an entry point for multicast/broadcast transmissions of a content provider providing broadcast or multicast data to communication devices situated in a geographical area served by the server.

In general, communications with communication devices may be provided as point-to-point communications or point-to-multipoint communications. Point-to-point communications are also known as unicasting. Point-to-multipoint communications, such as the MBMS service are provided by means of multicasting or broadcasting. A user can either joint a group to receive common data or the data can be transmitted such that a user is able to receive that transmitted data without any interaction between the end user and the entity responsible for sending the content.

The MBMS service is such that a shared stream of data is simultaneously transmitted to a multiple number of communication devices so that a number of recipients can receive the same data transfer flow.

Generally, MBMS transmissions are continuous transmissions.

MBMS services are generally provided in the context of 3GPP systems (3rd Generation Partnership Project), sometime referred to as “3G”. In accordance with this standard, a communication device typically operates in accordance with Wideband Code Division Multiple Access (WCDMA) requirements. However, other standards coexist with the so-called 3G standard. An example of such a coexisting standard is the GSM (Global System for Mobile communications). Often the 3G networks and GSM networks at least partially overlap. GSM uses Time Division Multiple Access (TDMA).

When a communication device is operating in a WCDMA mode but is also capable of working in accordance with the GSM standard, the communication device may monitor the surrounding GSM base stations. This is so that if the communication device needs to reselect/handover to a GSM base station it will be able to do this more smoothly.

The measurements of the GSM base stations made by the user equipment, when in the WCDMA mode are referred to as “InterRAT” (Radio Access Technology) measurements. In other words, the communication device while operating in accordance with one standard is making measurements of base stations operating in accordance with another standard.

In order to carry out the InterRAT measurements, a communication device having only a single receiver typically needs to create measurement gaps in the reception of a transmission in order to receive data on the GSM channels. This is so as to enable the GSM receiver of the user equipment to perform BSIC INIT (Base Station Identity Code Initialisation) procedures and BSIC refresh procedures. The BSIC INIT procedure refers to a RSSI (Received Signal Strength Indication) measurement, FCCH (Frequency Correction Channel) reception and SCH (Synchronisation Channel) reception. The BSIC refresh procedure refers to RSSI measurements and SCH reception.

It is currently proposed to provide measurement gaps in the reception of a continuous MBMS transmission at regular intervals. This means that part of the MBMS transmission is effectively lost because of the creation of these gaps. The information that is lost because of the creation of the gap is recreated using error correction. However, each gap in the data increases the dependence on error correction which reduces the capability of the channel coding to correct errors introduced by the radio channel when the radio conditions are demanding.

It is an aim of at least some exemplary embodiments of the present invention to address or at least partially mitigate this problem.

According to an example of the present invention there is provided a method comprising: interrupting the reception of a first transmission to receive a predetermined channel; determining from receipt of said predetermined channel first timing information associated with a second channel; and interrupting the reception of said first transmission at a time defined by said first timing information to receive said second channel.

According to an example of the present invention there is provided a device comprising: means for interrupting the reception of a first transmission to receive a predetermined channel; means for determining from receipt of said predetermined channel first timing information associated with a second channel; and means for interrupting the reception of said first transmission at a time defined by said first timing information to receive said second channel.

According to an example of present invention there is provided a device configured to: interrupt the reception of a first transmission to receive a predetermined channel; determine from receipt of said predetermined channel first timing information associated with a second channel; and interrupt the reception of said first transmission at a time defined by said first timing information to receive said second channel.

According to an example of present invention there is provided a computer program comprising at least one computer executable instruction which when run interrupts the reception of a first transmission to receive a predetermined channel; determines from receipt of said predetermined channel first timing information associated with a second channel; and interrupts the reception of said first transmission at a time defined by said first timing information to receive said second channel.

### BRIEF DESCRIPTION OF THE DRAWINGS

For a better understanding of the present invention and as to how the same may be carried into effect, reference will now be made by way of example to the accompanying drawings, in which:

FIG. 1 shows an example of a communications system in which embodiments of the present invention may be implemented;

FIG. 2 shows a communication device embodying the present invention;

FIG. 3 show a TDMA frame structure;

FIG. 4 schematically shows a block diagram of gaps provided in a MBMS reception;

FIG. 5 shows a flow chart illustrating an embodiment of the invention; and

FIG. 6 shows a device embodying the present invention.

### DETAILED DESCRIPTION OF EXEMPLARY EMBODIMENTS

In the following, certain exemplifying embodiments are explained with reference to wireless or mobile communications systems.

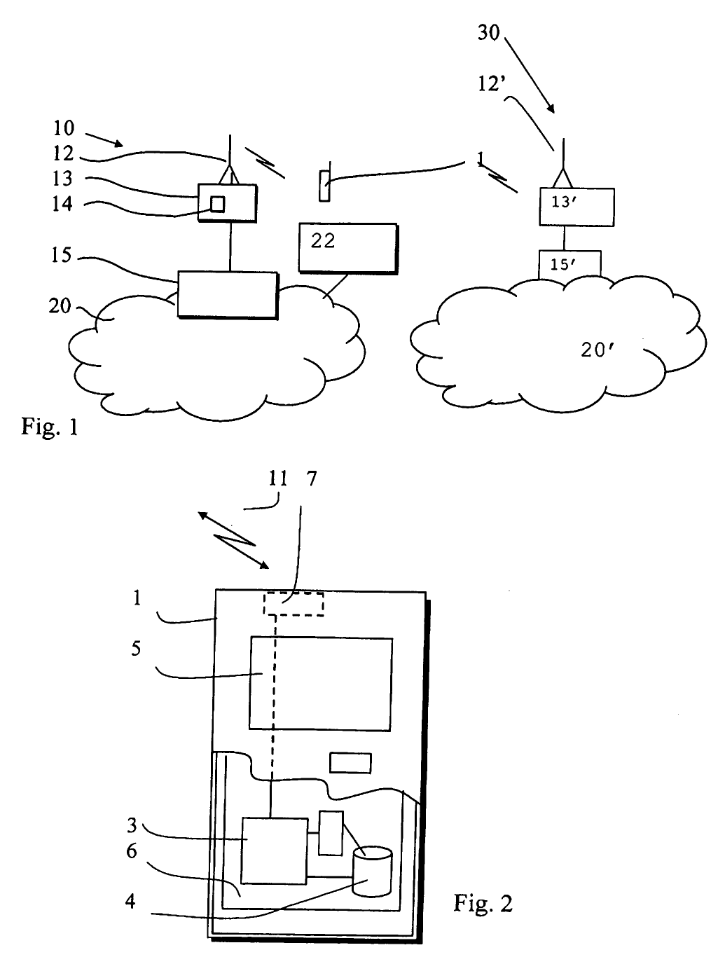

In this regard, reference is made to FIG. 1 which schematically shows a communications system in which embodiments of the present invention can be implemented along with a schematic view of a mobile communication device embodying the invention.

A communication device is used for accessing various services and/or applications provided via a communications system. In wireless or mobile systems, the access is provided via an access interface between a mobile communication device 1 and an appropriate wireless access system. In the embodiment shown in FIG. 1, two wireless access systems 10 and 30 are shown. In this example, the wireless access system 10 comprises a 3G wireless access system. This means that the mobile device 1 will communicate using WCDMA with at least one base station 12 of the first wireless access system 10. It should be appreciated that instead of a base station, a similar wireless transmitter and/or receiver node can be provided. Other examples of appropriate access nodes are a base station of a cellular system and a base station of a wireless local area network (WLAN).

In a typical mobile communication network, for example the cellular public landline mobile network (PLMN), an access system is provided by means of the base stations 12 (only one of which is shown for clarity). Each base station is arranged to wirelessly transmit signals to and receive signals from a plurality of mobile user equipment 1 (only one shown for clarity). The wireless communication between the user equipment and the base stations can be based on any appropriate communication protocol and access technology.

The mobile user equipment 1 is able to transmit wireless signals to and receive signals from the base stations 12. An appropriate user equipment 1, as will be described in more detail with reference to FIG. 2 has a radio part comprising radio transmission and receiving elements and a controller part so that it is enabled to send and receive information from the base stations, and process control instructions it may receive from or sent to the networks.

In the wireless access system 10, the base station 12 is typically controlled by at least one appropriate control entity 13 so as to enable operation thereof and management of mobile devices in communication with the base station. The controller entity is typically provided with memory capacity and at least one data processor marked 14. In FIG. 1 the base station 12 is connected to a data network 20 via an appropriate gateway 15 such as a packet data gateway and/or an access gateway.

In a common wireless system an access network enables the user equipment to access the core part of a communication network that links the access network to other access networks or communication networks. Each access network is typically provided with at least one controller 13 which may be connected to appropriate entities of the core network or networks. Only one access network controller 13 is shown in FIG. 1 for clarity. In FIG. 1 the core network 20 is presented as a cloud for simplicity, but typically it can consist of several elements such as Serving GPRS Support Node (SGSN), Gateway GPRS Support Node (GGSN), Mobile Switching Center (MSC) and so on.

As shown in FIG. 1, a MBMS node 22 is shown. This node comprises a server which is configured to broadcast or multicast information to multiple participants over a geographical area. This node 22 may serve as an entry point for transmission of a content service providing broadcast or multicast data to communication devices situated in a geographical area served by the node 22.

The service node 22 is connected to the data network 20. In the embodiment shown in FIG. 1, communications between the mobile device 1 and the MBMS server 22 are routed via the data network 20, the gateway 15 and the base station system 12 and 13.

In the embodiment shown in FIG. 1, the first network is a 3G network.

The second network 30 is a GSM network. In a similar manner to the network 10, at last one base station 12′ is provided. The base station is controlled by at least one appropriate controller entity 13′. The control entity 13′ is connected via an appropriate gateway 15′ to a network 20′. This network may take any suitable form. It should be appreciated that this network 20′ may be the same, partially the same or different to the network 20.

Non-limiting examples of access systems usable between the base station and the user equipment include access based on systems such as the CDMA (Code Division Multiple Access), WCDMA (Wide-band CDMA), TDMA (Time Division Multiple Access), FDMA (Frequency Division Multiple Access), or SDMA (Space Division Multiple Access) and hybrids thereof. In the example which is described, the first network is a CDMA network and the second network is a TDMA network.

The third generation (3G) Wideband Code Division Multiple Access (WCDMA) networks cells are controlled by control entities known as radio network controllers (RNC). In the second generation (2G) GSM (Global System for mobile) the cells of the access network are understood to be controlled by base station controllers (BSC). Typically an access network controller is connected to one of more elements of the core network 20.

It should be appreciated that the although elements 12, 13 and 15 (as well as the corresponding elements of the second network 30) are shown as distinct entities, functionality of at least one of these elements may be incorporated in at least one other of the entities. For example, the RNC functionality may be integrated with respective ones of the base stations.

FIG. 2 shows a schematically partially sectioned view of a communication device 1 that can be used for example receiving and displaying broadcast or multicast content, for example TV programmes or videos. Additionally, the device is, whilst it is receiving the MBMS transmission via the 3G network, able to monitor one or more base stations of the GSM network 30.

The communication device may be provided by any device capable of sending and receiving radio signals 11. Non-limiting examples include a mobile station (MS) a portable computer provided with a wireless interface card or other wireless interface facility, personal data assistant (PDA) provided with wireless communication capabilities, multimedia computers, smartphones or any combinations of these or the like.

The communications device 1 may receive signals via an appropriate radio receiver of the mobile device. In FIG. 2, the radio receiver is designated schematically by block 7. The receiver may be provided for example by means of a radio part and associated antenna arrangement. The antenna arrangement may be arranged internally or externally to the communications device.

The receiver arrangement of the communications device may be configured for enabling tuning to different carrier frequencies.

The communication device is also typically provided with at least one data processing entity 3, at least one memory 4 and other possible components for use in tasks it is designed to perform. The data processing, storage and other entities can be provided on an appropriate circuit board and/or in chip sets or on an appropriate integrated circuit. This is denoted by reference 6.

The user can control the operation of the mobile device by means of a suitable user interface such as a keypad, voice commands, touch sensitive screen or pad, combinations thereof or the like.

A display 5, a speaker and a microphone are all typically provided. Furthermore, a mobile device may comprise appropriate connectors, other either wired or wireless to other devices and/or for connecting external accessories such as for example hands free equipment or the like.

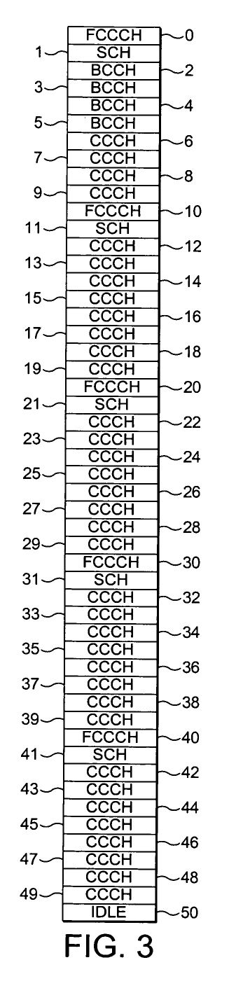

Reference is now made to FIG. 3 which shows a TDMA frame structure used for radio transmissions from a base station to the communication devices. The frame structure is based on a TDMA system. In particular, different channels are allocated particular time slots or positions in the frame.

As can be seen from FIG. 3, the FCCH channel is provided at slots 0, 10, and 30. The SCH channel is provided at positions 1, 11, 21 and 31.

The BCCH (Broadcast Control Channel) is provided at slots 2, 3, 4 and 5.

The CCCH (Common Control Channel) is provided at slots 6, 7, 8, 9, slots 12 to 19, slots 22 to 29 and slots 32 to 39 and slots 42 to 49. The last slot 50 is an idle slot.

As can be seen, the FCCH channel and the SCH channel are provided at given timeslots.

In order to complete an InterRAT measurement, it is necessary for the user equipment to monitor the frequency correction channel, which will provide frequency information for a particular monitored base station. Once that frequency information is obtained from the frequency correction channel, it is then necessary to obtain the synchronisation information from the synchronisation channel.

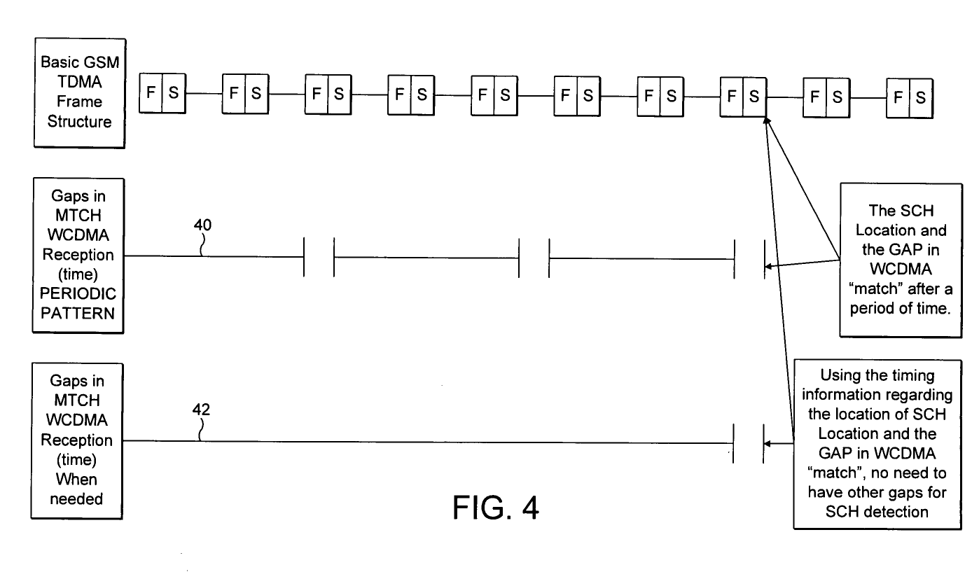

Reference is now made to FIG. 4 which schematically shows the principle of exemplary embodiments of the present invention. The basic GSM TDMA structure is shown with F representing the frequency correction channel and S representing the synchronisation channel. As can be seen, these channels are predetermined positions in the frame.

The user equipment is arranged to insert gaps into the MBMS reception. In other words, the MBMS transmission is a continuous transmission. For a predetermined short amount of time, the user equipment will stop listening to the MBMS channel and will listen for the FCCH channel of a neighboring GSM base station. The gaps are such that their spacing is either irregular or its period is such that after a predetermined time, the frequency channel of a neighbouring base station is located. This is shown in line 40 of FIG. 4.

The mobile station is arranged to use error correction information contained in the MBMS transmission to correct the MBMS data for the fact that not all the data has been received, due to the created gaps.

The prior art proposal for obtaining the SCH channel is such that it uses the same technique to locate the synchronised channel as the frequency channel. In other words, once the frequency channel is located, periodic gaps are introduced into the MBMS transmission in order to locate the synchronisation channel. This means that there will generally be a number of gaps required to be created in order to locate the SCH channel.

In exemplary embodiments of the present invention, once the FCCH channel has been located, the user equipment is arranged to make use of the fact that it can predict the location of the next SCH channel. For example, with reference to FIG. 3, assume that the FCCH channel on slot 11 has been located, the mobile station will know that there is a SCH channel 1 time slot later, 11 time slots later, 21 time slots later. In other words, instead of having to search for the synchronisation channel, the mobile station is arranged to schedule a gap say 11 time slots later in order to obtain the information on the synchronisation channel. This is shown in line 42 of FIG. 4.

Thus, exemplary embodiments of the present invention make use of the fact that the GSM is a TDMA system so decoding the SCH can be made easier as the location of that channel can be determined by the mobile device. Accordingly, the mobile device needs only to interrupt its reception of the MBMS signal when a guaranteed SCH channel location occurs. This means that there is a reduction in the gaps that are required in order to listen to a neighbouring base station.

This has the advantage in some exemplary embodiments of the invention in that the interruption to the MBMS reception is minimised thus reducing the block error rate. Each gap in the reception of the data increases the dependence on error correction. As mentioned previously, this reduces the capability of channel coding to correct errors introduced by the radio channel when radio conditions are demanding. Thus, exemplary embodiments of the present invention may improve the quality of reception of the MBMS signal.

The above-described embodiment relates to the acquisition of the information from a neighbouring GSM base station. It should be appreciated that in some exemplary embodiments of the present invention, this technique can be used to refresh the information held about a particular GSM station. In other words, at predefined intervals the user equipment can interrupt its reception of the MBMS signal to check the synchronisation channel of a particular GSM base station. It should be appreciated that this can be done at regular time intervals or when particular conditions change or occur. However, in this scenario, the user equipment again only needs to interrupt its MBMS reception when that communication device knows that it can decode the SCH channel.

In one exemplary embodiment of the present invention, the location or position of a SCH channel is located using a technique where the reception of the MBMS transmission is interrupted a plurality of times in order to locate that SCH channel. The TDMA structure means that the SCH locations are then known. This means that in order to carry out repeat measurements of the surrounding cells, the identified SCH locations or scheduled times are used to interrupt the reception of the MBMS transmission.

In exemplary embodiments of the present invention, the interruption in the reception of the MBMS transmission is controlled by the user equipment. This means that capacity can be improved as well as reducing noise on the received MBMS signal.

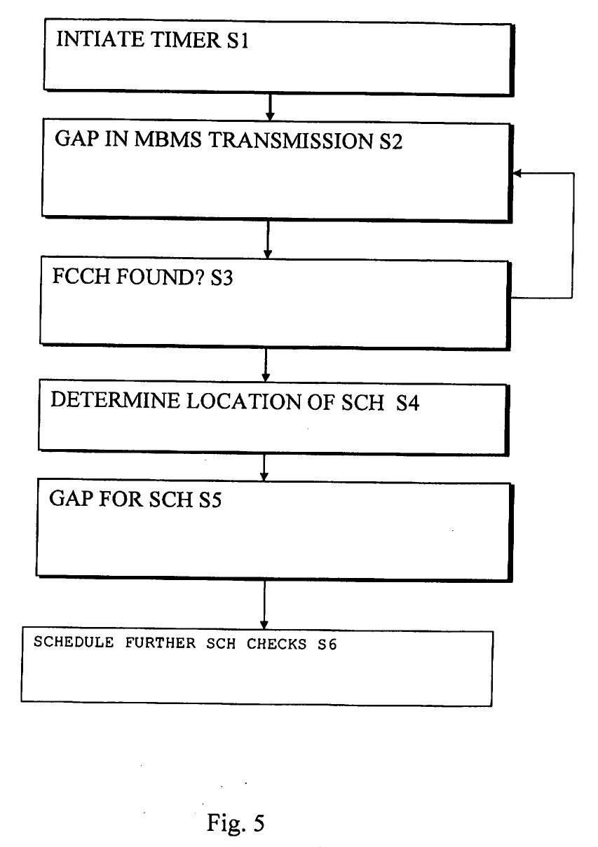

Reference is made to FIG. 5 which shows an example flow chart of a method embodying the present invention.

Firstly, a timer is initiated (S1).

Next, at a given time T, a gap is introduced into the reception of the MBMS signal (S2).

Next, it is determined whether or not the FCCH channel has been located (S3).

If the FCCH has been located, frequency information is obtained from that FCCH channel and the location of a subsequent associated SCH channel is determined based on the determined location of the FCCH (S4). In other words it is determined when the SCH can be received.

Next, a gap is introduced into the reception of the MBMS reception at the time associated with the location of the later SCH channel and the synchronisation information is obtained from the SCH. (S5)

Next, further locations of the SCH are determined and gaps are scheduled at a subsequent times when the SCH channel can be received to refresh the information held for a particular base station. This can be repeated a number of times to keep the information current. (S6)

However, if in S3, the location of the frequency channel is not obtained, then a new gap is scheduled in the reception of the MBMS signal and another attempt is made to locate the frequency channel. This continues until the frequency channel is located.

It should be appreciated that the timer is used in determining scheduling information associated with the synchronisation channel.

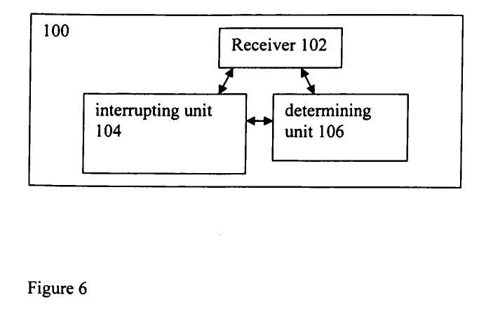

FIG. 6 shows a device embodying the device 100 embodying the invention. The device 100 has a receiver 102, an interrupting unit 104 and a determining unit 106. The interrupting unit 104 is configured to interrupt the reception of a first transmission by the receiver 102 to cause the receiver 102 to receive a predetermined channel. In other words, the interrupting unit controls when control of the controller 104 interrupts the reception of the transmission and receives a predetermined channel. Information received on the predetermined channel is passed to the determining unit 106. The determining unit is configured to determine from the predetermined channel first timing information associated with the second channel. This timing information is passed to the interrupting unit so that the interrupting unit is able to cause the receiver 102 to interrupt the reception of the first transmission at a time defined by the first timing information so that the second channel can be received.

A non-limiting example of mobile architectures where the above principles may be applied is known as the Evolved Universal Terrestrial Radio Access (E-UTRA). An exemplifying implementation may therefore be in the context of an evolved Universal Mobile Telecommunications System (UMTS), Terrestrial Radio Access Network (E-UTRAN). An Evolved Universal Terrestrial Radio Access Network (E-UTRAN) consists of E-UTRAN node Bs (eNBs) which are configured to provide both base station and control functionalities of the radio access network. The eNBs may provide E-UTRA features such as user plane Radio Link Control/Medium Access Control/Physical layer protocol (RLC/MAC/PHY) and control plane Radio Resource Control (RRC) protocol terminations towards the mobile devices.

It should be appreciated that exemplary embodiments of the invention can be used with different frame structures to that shown in FIG. 3.

Exemplary embodiments of the present invention have been described in the context of MBMS transmissions. It should be appreciated that exemplary embodiments of the present invention can be used with any other transmission which can be continuous and which may need to be interrupted to monitor channels the times of which can be known.

Exemplary embodiments of the present invention may be at least partially implemented in software. Accordingly, exemplary embodiments of the present invention can be implemented at least partially by a computer program when run on a suitable processor or computer. The computer program may be provided on a suitable computer program carrying media or an in the alternative may be downloaded from, for example a website or, for example via a specific server.

In this example, the two networks in question are a 3G network and a GSM network. It should be appreciated that exemplary embodiments of the present invention can be used with any other two types of network. Exemplary embodiments of the invention are particularly applicable to the case where one of the networks has a Time/Repetition based access system.

Exemplary embodiments of the present invention may be used with the proposed LTE (Long term evolution) system suggested in the 3GPP forum. Exemplary embodiments of the invention may be used with WiMax (Worldwide Interoperability for Microwave Access)

Additionally, exemplary embodiments of the present invention have been described in the context of receiving transmissions from one network and listening to another network. It should be appreciated that in some exemplary embodiments of the present invention, this technique can be used in a single network.

The exemplary embodiment described has been in the context of listening to a single base station. In practice, an user equipment may listen to a plurality of base stations in order to obtain the associated frequency and synchronisation information.

In the example described, the user equipment has listened to the frequency channel and the synchronisation channel. It should be appreciated that this is by way of example only. In some exemplary embodiments of the present invention, the user equipment may monitor a single channel. In this scenario, once the position of the given channel is located, fresh measurements can be made by scheduling measurement gaps at a time at which the channel can be received subsequently.

It should be appreciated that any other suitable channel or channels may be monitored in exemplary embodiments of the present invention.

Exemplary embodiments of the invention are particularly applicable to user equipment having a single receiver. Exemplary embodiments of the invention may be used with user equipment which have more than one receiver but where one receiver is required to receive two signals at the same time.

It should noted that although certain embodiments have been described by way of example with reference to exemplifying architectures of certain communications systems, exemplary embodiments of the present invention can be applied to any other suitable forms of communications system.

It should be appreciated that there are several variations and modifications which may be made to the above-described exemplifying embodiments, without departing from the scope of the present invention as defined in the appended claims.

1. A method, comprising:
interrupting the reception of a first transmission to receive a predetermined channel;
determining from receipt of said predetermined channel first timing information associated with a second channel; and
interrupting the reception of said first transmission at a time defined by said first timing information to receive said second channel.

2. A method as claimed in claim 1, wherein said predetermined channel comprises a frequency correction channel.

3. A method as claimed in claim 1 wherein said second channel comprises a synchronisation channel.

4. A method as claimed in claim 1, wherein said second channel is the same as the predetermined channel.

5. A method as claimed in claim 1, wherein said predetermined channel and said second channel comprise time division multiple access channels.

6. A method as claimed in claim 1, wherein said predetermined channel and said second channel have a predetermined timing relationship.

7. A method as claimed in claim 1, further comprising:
determining said timing information based on the time at which said predetermined channel is received.

8. A method as claimed claim 1, further comprising:
obtaining information on a node in dependence on information from at least one of said predetermined channel and said second channel.

9. A method as claimed in claim 1, further comprising:
obtaining at least one of frequency and synchronisation information from at least one of said predetermined channel and said second channel.

10. A method as claimed in claim 1, further comprising:
determining second timing information associated with said second channel, said second timing information being later than the first timing information and interrupting the reception of said first transmission at a time defined by said second timing information to receive said second channel a further time.

11. A method as claimed in claim 1, further comprising:
error correcting said first transmission to correct for said interruptions in said reception.

12. A method as claimed in claim 1, wherein said first transmission comprises a Multimedia Broadcast/Multicast Service transmission.

13. A device comprising:
an interrupt unit configured to interrupt the reception of a first transmission to receive a predetermined channel;
a determining unit to determine from receipt of said predetermined channel first timing information associated with a second channel; and
said interrupt unit configured to interrupt the reception of said first transmission at a time defined by said first timing information to receive said second channel.

14. A device as claimed in claim 13, wherein said predetermined channel comprises a frequency correction channel.

15. A device as claimed in claim 13, wherein said second channel comprises a synchronisation channel.

16. A device as claimed in claim 13, wherein said second channel is the same as the predetermined channel.

17. A device as claimed in claim 13, wherein said predetermined channel and said second channel comprise time division multiple access channels.

18. A device as claimed in claim 13, wherein said predetermined channel and said second channel have a predetermined timing relationship.

19. A device as claimed in claim 13, wherein the device is further configured to determine said timing information based on the time at which said predetermined channel is received.

20. A device as claimed in claim 13, wherein the device is further configured to obtain information on a node in dependence on information from at least one of said predetermined channel and said second channel

21. A device as claimed in claim 13, wherein the device is further configured to obtain at least one of frequency and synchronisation information from at least one of said predetermined channel and said second channel.

22. A device as claimed in claim 13,
wherein the device is further configured to determine second timing information associated with said second channel, said second timing information being later than the first timing information, and
wherein the device is further configured to the reception of said first transmission at a time defined by said second timing information to receive said second channel a further time.

23. A device as claimed in claim 13, wherein the device is further configured to error correct said first transmission to correct for said interruptions in said reception.

24. A device as claimed in claim 13, wherein said first transmission comprises a Multimedia Broadcast/Multicast Service transmission.

25. A device, comprising:
means for interrupting the reception of a first transmission to receive a predetermined channel;
means for determining from receipt of said predetermined channel first timing information associated with a second channel; and
means for interrupting the reception of said first transmission at a time defined by said first timing information to receive said second channel.
